(19) United States
(12) Patent Application Publication
(10) Pub. No.: US 2025/0294034 A1
(43) Pub. Date: Sep. 18, 2025

(54) JOINT OVERFITTING TEST FOR CLIENT ISOLATION DETECTION IN FEDERATED LEARNING

(71) Applicant: Dell Products L.P., Round Rock, TX (US)

(72) Inventors: Maira Beatriz Hernandez Moran, Rio de Janeiro (BR); Paulo Abelha Ferreira, Rio de Janeiro (BR); Pablo Nascimento da Silva, Niterói (BR)

(21) Appl. No.: 18/606,271

(22) Filed: Mar. 15, 2024

(51) Int. Cl. H04L 9/40

(52) U.S. Cl. CPC H04L 63/1416

(57) ABSTRACT

A joint overfitting method for detecting client isolation attacks in a federated learning system. Clients generate overfitting scores related to training a local model with local data. Multiple clients share their overfitting scores with each other such that each client can compare their overfitting scores with the overfitting scores of other clients. This allows anomalous scores to be identified. When anomalous scores, such as scores that relate to different distributions, are identified, the client is identified to a server and a security protocol may be initiated.

### RELATED APPLICATIONS

This application is related to U.S. Ser. No. 17/937,842 filed Oct. 4, 2022, and entitled DETECTING CLIENT ISOLATION ATTACKS IN FEDERATED LEARNING THROUGH OVERFITTING MONITORING (hereinafter OVERFITTING MONITORING), which application is incorporated by reference in its entirety.

### FIELD OF THE INVENTION

Embodiments of the present invention generally relate to federated learning systems and processes. More particularly, at least some embodiments of the invention relate to systems, hardware, software, computer-readable media, and methods for detecting the occurrence of a client isolation attack in a federated learning system.

### BACKGROUND

Federated learning is often implemented as a distributed framework for machine learning in which a global model is trained jointly by several nodes without ever sharing their local data. Federated learning is an essential area for companies interested in providing infrastructure for private distributed machine learning (e.g., massive deployment of machine learning models to the edge where data must be kept local due to compliance, cost, or strategic reasons).

Federated learning implements strong privacy guarantees. However, federated learning suffers from specific security issues not necessarily present in other machine learning scenarios. One of the most efficient privacy attacks is client isolation. The main idea behind this type of attack relates to the fact that inferring data of a target client from a global model is very difficult, because the model was updated using data from multiple clients in addition to the target client. A client isolation attack attempts to isolate the client from global updates. The attacker thereby has a better chance to infer the local data of the target client.

In a general federated learning setting, clients do not typically perform any verification that allows the clients to detect that they are subject to an isolation attack. More specifically, there is a lack of defense mechanisms that allow clients to determine or verify whether they are being victimized by an isolation attack.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of an isolated client attack;

FIG. 2A discloses aspects of a protocol for detecting overfitting at a client;

FIG. 2B discloses aspects of pseudocode for detecting a client isolation attack;

FIG. 3 discloses aspects of a method for joint overfitting verification;

FIG. 4 discloses aspects of distribution types for data such as overfitting scores;

FIG. 5 discloses aspects of comparing overfitting scores of different clients in a federated learning system; and

FIG. 6 discloses aspects of a computing device, system, or entity.

### DETAILED DESCRIPTION OF SOME EXAMPLE EMBODIMENTS

Embodiments of the present invention generally relate to federated learning processes. More particularly, at least some embodiments of the invention relate to systems, hardware, software, computer-readable media, and methods for detecting a client isolation attack in a federated learning system. In one example, clients or nodes may participate in a joint overfitting analysis to determine whether any of the nodes may be subject to or is experiencing a client isolation attack. Any of the nodes or clients participating in the joint overfitting analysis can identify the node or client being attacked. Embodiments of the invention relate to detecting client isolation attacks in federated learning scenarios and/or to providing resilience to client isolation attacks.

As previously indicated, one objective of client isolation attacks is to isolate a client from the rest of the federation. This prevents the client from accessing the model updates provided by other clients that are reflected in global model updates. At a client subject to a client isolation attack, local training results in a biased model that may facilitate data leakage.

In most federated learning settings, defense mechanisms are implemented on the server side because many security threats in federated learning are carried out by malicious clients/nodes. This may expose honest clients to malicious server security threats at least because clients do not perform any validation of the global model sent by the server, which can be manipulated in order to promote privacy vulnerabilities. As a result, establishing a verification to be performed by the clients to validate the global model would aid in protecting the clients and the federated learning system from client isolation attacks.

Embodiments of the invention further relate to overfitting tests that allow ongoing client isolation attacks to be detected and that incorporate multiple clients in the analysis. More specifically, even if a node or client may appear to be under a client isolation attack due to a legitimate behavior that appears to be an overfitting trend, embodiments of the invention further perform overfitting operations that allow overfitting trends at one client or node to be compared with overfitting trends at other clients or nodes. This allows a client or node to determine how much the node deviates from the federation and determine whether the node is subject to an ongoing client isolation attack.

Embodiments of the invention more specifically relate to joint overfitting verification to detect, prevent, remedy and/or provide resilience to client isolation attacks. Client isolation attacks may be detected using overfitting scores. Clients in the federated system can each generate their own overfitting scores and these overfitting scores can be compared to the overfitting scores of other clients. Overfitting scores that do not comport with the other overfitting scores are suspicious and may indicate a client isolation attack.

Generally, client isolation attacks are detected/prevented/defended by (i) generating an overfitting score for each round of local training for each client, (ii) generating a distribution to denote the overfitting trends for all federation clients, and (iii) comparing these distributions for signs of a potential attack.

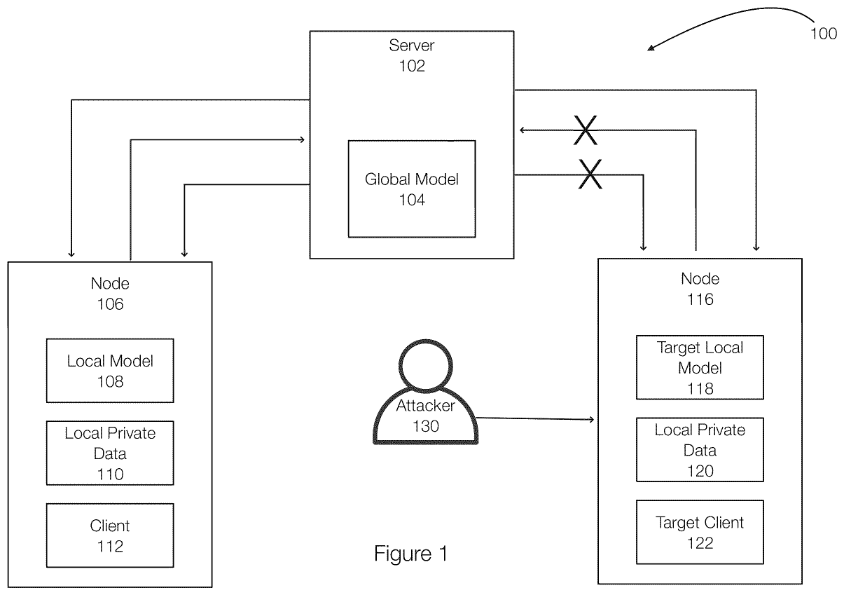

FIG. 1 discloses aspects of a client isolation attack in a federated learning system. FIG. 1 illustrates a federated learning system 100. The system 100 includes a server 102 configured to generate/update a global model 104. The clients 112 and 122, which may be running on the nodes 106 and 116, each have, respectively, local models 108 and 118. The client 112 trains the local model 108 using the local private data 110 and the client 122 trains the local model 118 using the local private data 120.

More specifically, in normal federated learning settings, the server 102 provides an initial model 104 to the clients 112 and 122. Thus, the local models 108 and 118 correspond, prior to local training, the global model 104. The clients 112 and 122 perform local training, using their private datasets 110 and 120. As a result of this local training, the local models 108 and 118 are modified to fit the private data 110 and 120. The updates to the local models 108 and 118 are sent to the server 102. The server 102 aggregates the updates from all of the clients 112 and 122 to obtain or generate an updated global model. The updated global model is sent back to the clients 112 and 122, and the process repeats iteratively. One benefit of federated learning is that the clients 112 and 122 each have a model 108 and 118 that fits not only their own private data 110 and 120, but also the data of other clients. Federated learning results in good generalization in the global/local models.

When a client isolation attack occurs, an attacker 130 assumes the role of the server 102 for, in this example, the client 122. As a result of this attack, the client 122 is prevented from communicating with the server 102 and therefore does not receive any model updates from the server 102. The attacker 130 strategically send the model 118 back to the client 122. Thus, the model received by the client 122 only includes updates based on training with the private data 120.

Because the model 118 is being trained in a manner that only considers the same local private data 120, the model 118 is adversely impacted. This attack accentuates the influence of the private data 120 on the local model 118. This increases the generalization error of the local model 118 and results in an overfitted model. Overfitting is observed by a much greater loss in new samples when compared to loss values achieved for the training data set, which in the contest of a client isolation attack is the private data 120. As a result of this attack, the attacker 130 may be able to infer the local private data 120.

More specifically, after the attacker 130 achieves an overfitted model through a client isolation attack, other procedures can be performed to infer the private data 120. Examples of possible post-isolation approaches include applying a gradient ascent technique to infer data from the target model 118, implementing classification models to determine if a record was part of the target model training set, or the like.

In some examples, the generalization behavior of the local model 118 is a strong predictor of vulnerability to inference attacks. In other words, attack success and generalization error are closely related in most common learning settings.

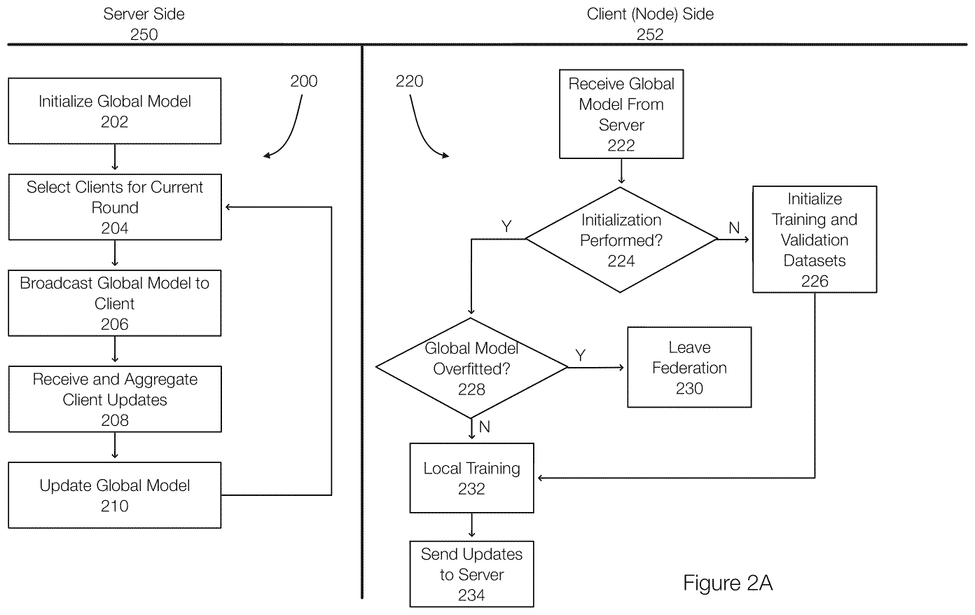

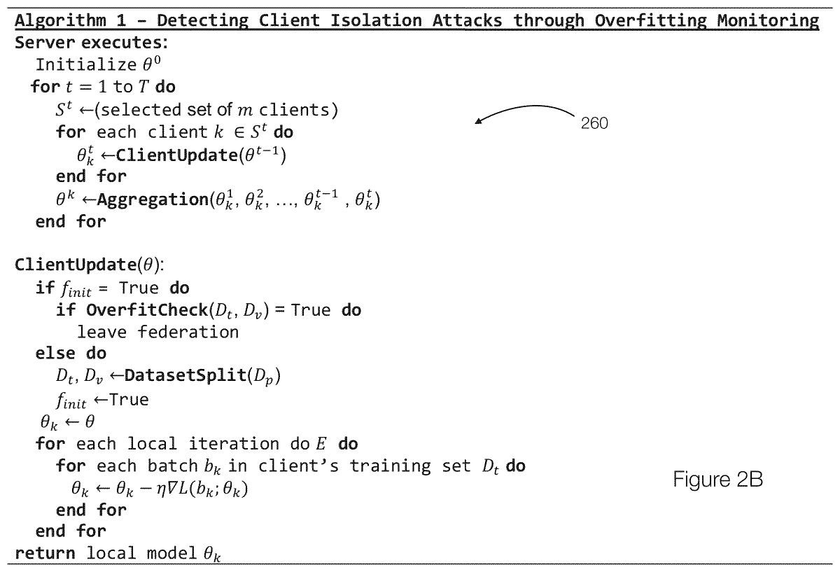

FIG. 2A discloses aspects of a local overfitting based protocol for client isolation attacks. FIG. 2A illustrates aspects of this protocol from the server side 250 and the client side 252. On the server side 250, a method 200 includes initializing 202 a global mode. Clients for a current round of training are selected 204. In some examples, less than all of the clients in the federated learning system may participate in a given training round.

Next, the global modal is broadcast 206 to the selected clients. After local training 220, the server receives and aggregates 208 the updates to the model received from the selected clients that participated in the training round. The global model is updated 210 and the process repeats by selecting clients for the next training round. The federated learning method 200 is performed iteratively until, in one example, the updates converge to a desired error threshold in one example or after a predetermined number of training rounds.

On the client side 252, the method 220 includes receiving 222 a global model from the server. If initialization at the client has not been performed (N at 224), the training and validation datasets are initialized 226 and local training is performed 232. More specifically, the dataset of the client may be divided into a training dataset and a validation dataset. The validation dataset is not used for training purposes.

If initialization at the client has been performed (Y at 220), the client engages with the federation. In this example, the client determines 228 whether the global model received for this training round is overfitted. If the model is overfitted (Y at 228), the client may leave 230 the federation. If the model is not overfitted (N at 228), local training is performed 232 and updates are sent 234 to the server. When determining whether the global model is overfitted, the validation dataset may be used.

FIG. 2B discloses aspects of pseudocode 260 for identifying a client isolation attack. The pseudocode 260 is representative of the methods 200 and 220 in FIG. 2A.

Embodiments of the invention more specifically relate to a protocol of joint overfitting verification that includes the participation of multiple clients. While FIGS. 2A and 2B illustrates to client isolation attacks from the perspective of a single client, embodiments of the invention further relate to detecting client isolation attacks from a more global perspective that accounts for the perspectives and views of other clients in the federated learning system. Embodiments of the invention provide an informed global opinion on how much a particular client is overfitting with respect to other clients in the federated learning system.

In one example, each node or client may initiate the joint verification protocol. In another example, each node or client that suspects a client isolation attack may initiate the protocol.

In both of these scenarios, all nodes or client maintain a history of their last K training and validation losses and a calculation of the latest overfitting score using these values. The method for performing the calculation may vary. In one example, a difference between the validation loss and the training loss may be evaluated. The differences or difference trend at one client can be compared with the differences or difference trend at other clients. Clients that deviate from an expected to typical difference trend may be subject to an isolation attack.

In order to ensure that multiple clients can participate in the joint verification protocol, cryptographic keys may be used such that the scores used in detecting a client isolation attack can be verified or authenticated.

Thus, in one example, each node or client may have a private key and the other clients have the corresponding public key. This allows each node to uniquely and authentically sign a message. Thus, all nodes or clients participating in the joint overfitting protocol can determine their own overfitting scores and request a set of scores from M other clients. The scores can be securely shared using the private/public keys.

When a node or client has access to its own scores and the scores of other clients, the client can compare these scores. If any of these scores differ substantially or beyond a threshold or in other manners, a high value of suspicion may be applied to that node or client whose scores seem out of place. If the score of a node denotes or suggests that the client is under attack, this suspicion can be communicated to the server by any of the other nodes. Signed messages help prevent the attacker from forging these communications because the attacker does not have access to private keys from the M nodes participating in the joint overfitting protocol.

In one example, the joint overfitting protocol may generally proceed as follows for a given node i:
(1) Node i asks for the current overfitting scores from a subset M of all nodes in the federated learning system;
(2) Each node from which an overfitting score is requested communicates their scores to the node i by signing it with its private key (node i also communicates its signed scores to all M nodes);
(3) Node i then uses the public keys of the M nodes to verify and decrypt each of the M overfitting scores;
(4) Node i then builds a distribution of these M scores and checks how close its own overfitting score or distribution is to the distributions of the other nodes;
(5a) If node i's overfitting scores are too far away from the other distributions, node i may be deemed suspicious or suspect and a defined security protocol may be initiated;
(5b) All M Nodes also compute Node i's overfitting scores and if Node i's scores denotes suspicion, they communicate the signed result back to the server; and
(6) If the server receives a message from any node regarding another node, the server starts its own security protocol to deal with this potential breach. In one example, the security protocol includes removing the suspicious node from the federation.

In the foregoing method, step or act 5a occurs from its own perspective. However, this node i may or may not be able to communicate with the server. However, the node i may be able to take steps to protect itself based on this analysis. The act or step 5b ensures that the server is aware of the potential attack at the node i and allows the server to take protective actions. Thus, multiple clients may perform a similar joint verification protocol and any of the clients may be able to determine which of the other clients may be under attack.

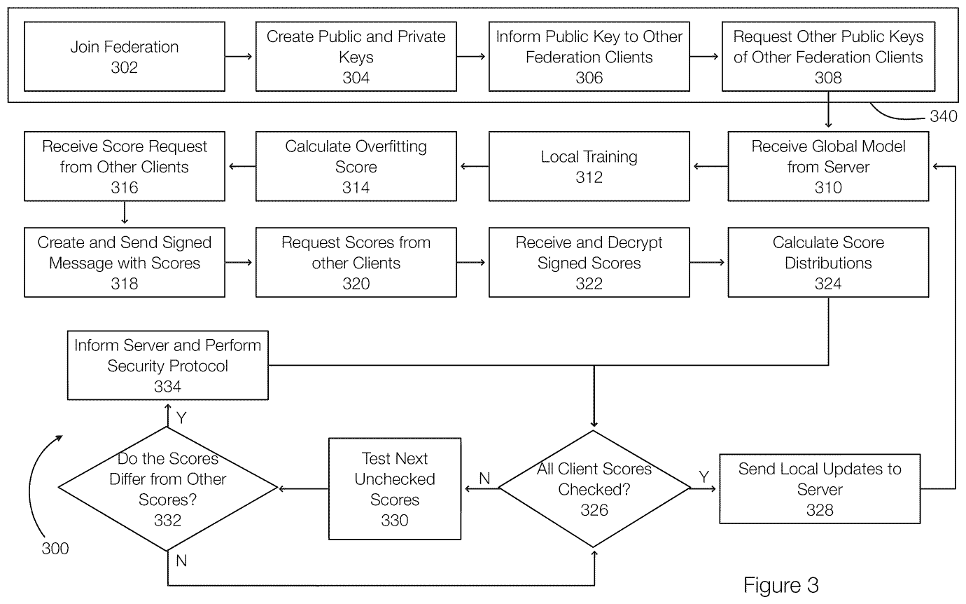

FIG. 3 discloses aspects of performing a joint overfitting protocol. Overfitting, in one example, is a phenomenon in which a model is over trained and has learned in a manner that is only applicable to the training samples. In other words, the model is not generalizable to the overall data population and cannot deal with samples or data that are outside of the training dataset.

The method 300 is disclosed in the context of determining whether a client is subject to or is experiencing a client isolation attack and is based, in one example, on a measurement of a clients overfitting scored compared to the overfitting scores of other clients. Some acts of steps of the method 300 may be performed separately and independently of other acts or steps. For example, the method 300 may include an initialization phase 340 for onboarding a client to the federation. In the method 300, a client may join 302 a federation and, as part of the joining process, a private/public key pair is created 304 generated for the client. Other clients of the federation are informed 306 of the public key for the client. The client may also request 308 public keys for the other clients that are part of the federation. Thus, each client in the federation has the public keys of the other clients in the federation.

At this point, the operational phase of federated learning may begin. More specifically, federated learning may begin when a client receives 310 a global model from the server. Local training is performed 312 and an overfitting score 314 is determined for the training round.

The client may receive 316 a score request from other clients in the federation. The client may create and send 318 a signed message that includes the overfitting score (or a set of overfitting scores) in response to the score requests received from other clients. The client may also request 320 scores from the other clients. Thus, at least a set of M nodes or clients each have overfitting scores from each of the M nodes or clients. The scores are thus received 322 and decrypted.

Next, the client may calculate 324 score distributions for the other clients and/or for itself. Because the overfitting scores may include overfitting scores for K training rounds, a distribution of the scores may be generated.

FIG. 3 illustrates an iterative process where the client compares their own score distribution with the score distributions of the other clients. More specifically, a client determines whether any of the scores received from the other clients need to be checked or compared against the client's scores. If all scores have not been checked (N at 326), the next unchecked score is tested 330. If the score does not differ more than a threshold (N at 332), the next score is checked.

If all of the scores or distributions received from the other clients have been checked (Y at 326) and nothing suspicious was identified, the local updates may be sent 328 to the server and the training process repeats from 310 after the local updates are applied to the global model.

If, however, the score of the client differs more than a threshold (Y at 332), the server is informed 334 and a security protocol is invoked. The specific action performed at the client may depend on whether the client itself is subject to attack or whether the client believes that one of the other clients is subject to attack as previously described (5a and 5b above).

In one example, overfitting may be determined by observing learning curve plots. In one example, the model may continue to improve its performance on a training dataset. However, for a client being attacked, the performance on the test or validation dataset may improve to a point and then degrade. This performance can be analyzed by checking the model's loss and accuracy values on both the training dataset and the validation dataset. If the model, after achieving a good low training loss, continually decreases its training loss, while the validation loss starts to go up, this is an indication of overfitting. That is, the model is becoming very good as tested on the training set, but the performance of the model starts to deteriorate as measured by the validation dataset. Because the validation dataset is supposed to be a dataset that includes data the model has not been exposed to, the model is overfitting on the training dataset when model starts to perform poorly on the validation dataset. In other words, the model is memorizing the training set, therefore performing well on the training dataset. At the same time, the model is starting to perform poorly on the validation dataset, because the model has not really learned a good generalization from the training set, but merely memorized training dataset.

In one example, the scores are used to generate a distribution that properly describes the scores. Several types of distributions can be tested to measure how well they express the data. For example, the distributions can be tested in terms of their goodness of fit, which can be estimated by various metrics like Chi-square statistics, Kolmogorov-Smirnov test, etc.

By way of example only, the Kolmogorov-Smirnov test (KS test) may be used because the KS test includes a highly adopted solution for determining the goodness of fit of a distribution for data. Thus, the KS test could consider a set of distribution types, such as normal, exponential, gamma, Poisson, etc., and test how these distribution types describe the data. The parameters that defined the corresponding distribution may also be determined. By considering the distribution with the highest goodness of fit, the appropriate distribution is established for the data being considered.

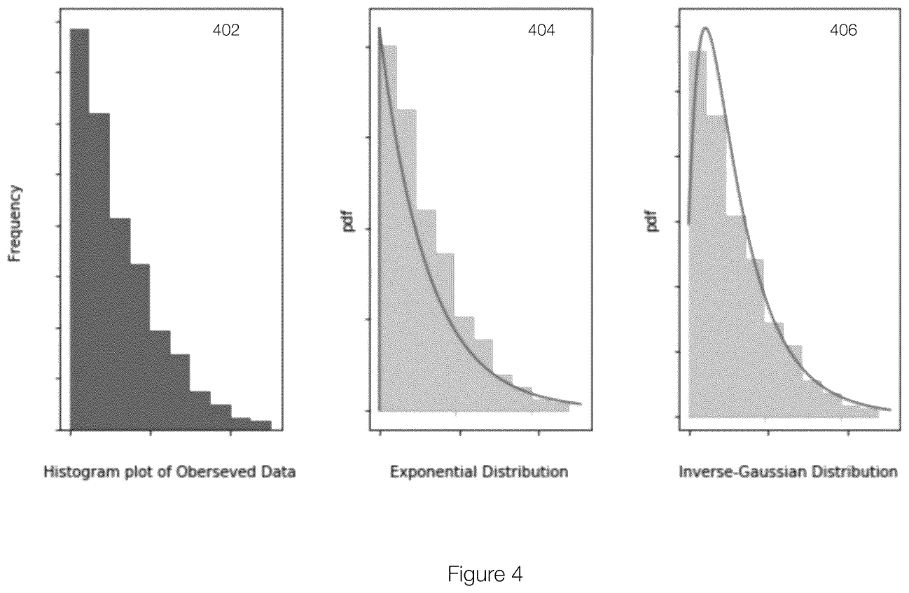

FIG. 4 illustrates a visual comparison between the goodness of fit for the same data considering two difference distributions. FIG. 4 illustrates an exponential distribution 404 for the data 402 and an inverse-gaussian distribution 406 for the same data 402.

In the method 300, after the scores are received, distributions may be determined. Identifying an attack may include comparing the potential victim's overfitting scores (or distribution) with the other clients' distributions. If the potential victim's overfitting scores substantially differ from the others, i.e., if the scores do not fit the same distribution, the protocol indicates that this client is probably under an attack. Although various options are available, one example for comparing the overfitting scores to another distribution is the two-sample KS test. This test checks if two different samples came from the same distribution. In this way, the scores of the other clients can be tested and checked to determine if they came from the same distribution. If the p-value of the test denotes otherwise, an attack is a possibility and a security protocol may be invoked.

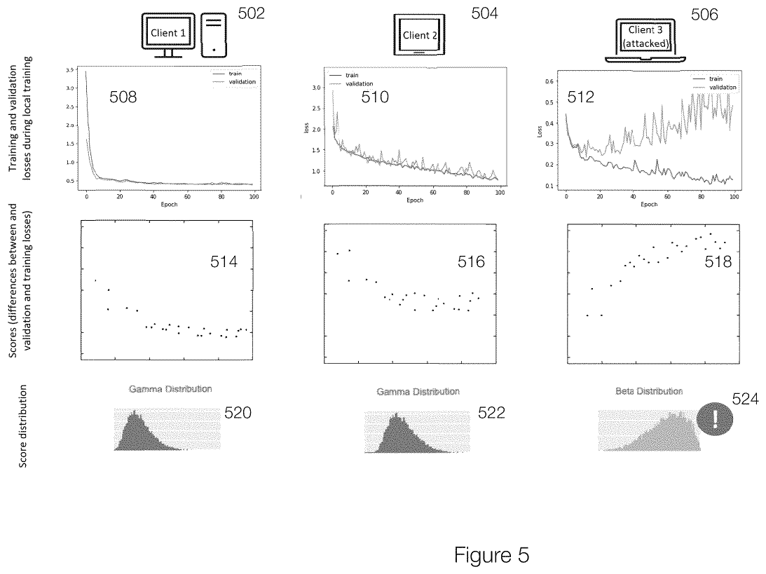

FIG. 5 discloses aspects of detecting a client isolation attack in federated learning. FIG. 5 illustrates clients 502, 504, and 506. In this example, the client 502 is associated with a plot 508 of training and validation losses during local training, a plot 514 illustrating scores (e.g., differences between validation and training losses), and a distribution 520, which is a gamma distribution in this example. The clients 504 and 506 are similarly associated with, respectively, plots 510 and 512, plots 516 and 518, and distributions 522 and 524.

FIG. 5 illustrates that samples from the distribution 524 and 522 do not come from the same or presumably the same distribution. When the joint overfitting protocol is performed, this analysis, which may be performed at each of the clients (or at least a subset thereof) illustrates that the scores of the client 506 do not fit or are different from the scores of other clients. Thus, the client 506 is likely under attack and a security protocol may be performed.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, model and model-related operations, overfitting related operations, joint overfitting operations, distribution and/or comparison operations, security protocol operations, or the like. More generally, the scope of the invention embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment. In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers or VMs, or any combination of these, though no particular device implementation or configuration is required for any embodiment. Similarly, data storage system components such as databases, storage servers, storage volumes (LUNs), storage disks, for example, may likewise take the form of software, physical machines, containers, or virtual machines (VMs), though no particular component implementation is required for any embodiment.

As used herein, the term ‘data’ is intended to be broad in scope. Example embodiments of the invention are applicable to any system capable of storing and handling various types of objects, in analog, digital, or other form.

It is noted that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A method comprising: requesting, by a first client, overfitting scores from each client in a subset of clients in a federated learning system, receiving the overfitting scores from the clients in the subset of clients at the first client and building a distribution for each of the overfitting scores received from the subset of clients, determining that the overfitting scores of a particular client are suspicious based on a comparison of overfitting scores of the first overfitting with the overfitting scores received from the subset of clients, and initiating a security protocol.

Embodiment 2. The method of embodiment 1, wherein the overfitting scores are based on learning curve plots, wherein the overfitting scores of the particular client are determined as suspicious when accuracy with regard to a training dataset increases while accuracy with regard to a validation dataset decreases.

Embodiment 3. The method of embodiment 1 and/or 2, further comprising determining that the overfitting scores of the particular client are suspicious when the overfitting scores of the particular client do not fit a same distribution as the overfitting scores from other clients.

Embodiment 4. The method of embodiment 1, 2, and/or 3, further comprising comparing the overfitting scores of the first client with the overfitting scores of the other clients using a two sample KS test.

Embodiment 5. The method of embodiment 1, 2, 3, and/or 4, wherein the particular client is not the first client and wherein the first client notifies a server of the federated learning system that the particular client may be subject to a client isolation attack, wherein the server initiates the security protocol.

Embodiment 6. The method of embodiment 1, 2, 3, 4, and/or 5, wherein the security protocol includes removing the particular client from the federated learning system.

Embodiment 7. The method of embodiment 1, 2, 3, 4, 5, and/or 6, wherein the particular client is the first client, further comprising initiating the security protocol at the first client.

Embodiment 8. The method of embodiment 1, 2, 3, 4, 5, 6, and/or 7, further comprising performing training rounds iteratively.

Embodiment 9. The method of embodiment 1, 2, 3, 4, 5, 6, 7, and/or 8, wherein at least some of the clients in each of the training rounds perform the joint overfitting protocol to determine whether any of the clients are subject to a client isolation attack.

Embodiment 10. The method of embodiment 1, 2, 3, 4, 5, 6, 7, 8, and/or 9, wherein the overfitting scores are shared using cryptography such that each sending client encrypts the corresponding overfitting scores using a private key, wherein receiving clients decrypt the overfitting scores using corresponding public keys.

Embodiment 11. A method comprising: requesting, by a first client, overfitting scores from each client in a subset of clients in a federated learning system, wherein the overfitting scores relate to changes in a loss related to a training dataset changes in a loss related to a validation dataset, receiving the overfitting scores from the clients in the subset of clients at the first client, determining that the overfitting scores of a particular client are suspicious based on a comparison of overfitting scores of the first overfitting with the overfitting scores received from the subset of clients, wherein the overfitting scores of the particular client are suspicious when the loss related to the training dataset is improving while the loss related to the training dataset is worsening, and initiating a security protocol.

Embodiment 12. A system, comprising hardware and/or software, operable to perform any of the operations, methods, or processes, or any portion of any of these, disclosed herein.

Embodiment 13. A non-transitory storage medium having stored therein instructions that are executable by one or more hardware processors to perform operations comprising the operations of any one or more of embodiments 1-11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, agent, client, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

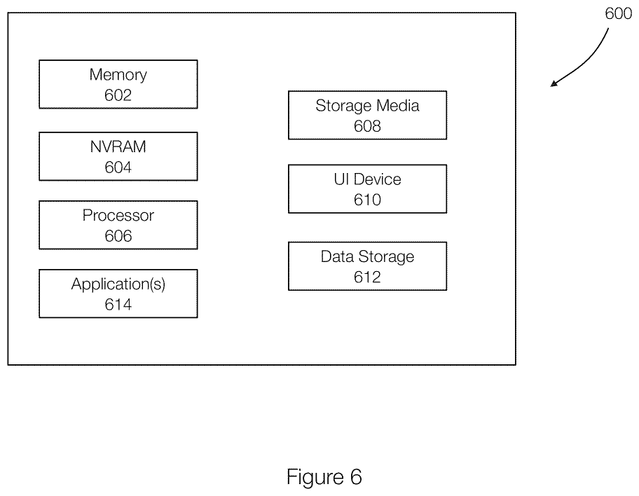

With reference briefly now to FIG. 6, any one or more of the entities disclosed, or implied, by the Figures, and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
requesting, by a first client, overfitting scores from each client in a subset of clients in a federated learning system;
receiving the overfitting scores from the clients in the subset of clients at the first client and building a distribution for each of the overfitting scores received from the subset of clients;
determining that the overfitting scores of a particular client are suspicious based on a comparison of overfitting scores of the first overfitting with the overfitting scores received from the subset of clients; and
initiating a security protocol.

2. The method of claim 1, wherein the overfitting scores are based on learning curve plots, wherein the overfitting scores of the particular client are determined as suspicious when accuracy with regard to a training dataset increases while accuracy with regard to a validation dataset decreases.

3. The method of claim 1, further comprising determining that the overfitting scores of the particular client are suspicious when the overfitting scores of the particular client have a sufficiently dissimilar distribution to the distribution of overfitting scores from other clients.

4. The method of claim 1, further comprising comparing the overfitting scores of the first client with the overfitting scores of the other clients using a two sample KS test.

5. The method of claim 1, wherein the particular client is not the first client and wherein the first client notifies a server of the federated learning system that the particular client may be subject to a client isolation attack, wherein the server initiates the security protocol.

6. The method of claim 5, wherein the security protocol includes removing the particular client from the federated learning system.

7. The method of claim 1, wherein the particular client is the first client, further comprising initiating the security protocol at the first client.

8. The method of claim 1, further comprising performing training rounds iteratively.

9. The method of claim 8, wherein at least some of the clients in each of the training rounds perform the joint overfitting protocol to determine whether any of the clients are subject to a client isolation attack.

10. The method of claim 1, wherein the overfitting scores are shared using cryptography such that each sending client encrypts the corresponding overfitting scores using a private key, wherein receiving clients decrypt the overfitting scores using corresponding public keys.

11. A non-transitory storage medium having stored therein instructions that are executable by one or more hardware processors to perform operations comprising:
requesting, by a first client, overfitting scores from each client in a subset of clients in a federated learning system;
receiving the overfitting scores from the clients in the subset of clients at the first client and building a distribution for each of the overfitting scores received from the subset of clients;
determining that the overfitting scores of a particular client are suspicious based on a comparison of overfitting scores of the first overfitting with the overfitting scores received from the subset of clients; and
initiating a security protocol.

12. The non-transitory storage medium of claim 11, wherein the overfitting scores are based on learning curve plots, wherein the overfitting scores of the particular client are determined as suspicious when accuracy with regard to a training dataset increases while accuracy with regard to a validation dataset decreases.

13. The non-transitory storage medium of claim 11, further comprising determining that the overfitting scores of the particular client are suspicious when the overfitting scores of the particular client do not fit a same distribution as the overfitting scores from other clients.

14. The non-transitory storage medium of claim 11, further comprising comparing the overfitting scores of the first client with the overfitting scores of the other clients using a two sample KS test.

15. The non-transitory storage medium of claim 11, wherein the particular client is not the first client and wherein the first client notifies a server of the federated learning system that the particular client may be subject to a client isolation attack, wherein the server initiates the security protocol.

16. The method of claim 5, wherein the security protocol includes removing the particular client from the federated learning system.

17. The non-transitory storage medium of claim 11, wherein the particular client is the first client, further comprising initiating the security protocol at the first client.

18. The non-transitory storage medium of claim 11, further comprising performing training rounds iteratively, wherein the overfitting scores are shared using cryptography such that each sending client encrypts the corresponding overfitting scores using a private key, wherein receiving clients decrypt the overfitting scores using corresponding public keys.

19. The non-transitory storage medium of claim 18, wherein at least some of the clients in each of the training rounds perform the joint overfitting protocol to determine whether any of the clients are subject to a client isolation attack.

20. A method comprising:
requesting, by a first client, overfitting scores from each client in a subset of clients in a federated learning system, wherein the overfitting scores relate to changes in a loss related to a training dataset changes in a loss related to a validation dataset;
receiving the overfitting scores from the clients in the subset of clients at the first client;
determining that the overfitting scores of a particular client are suspicious based on a comparison of overfitting scores of the first overfitting with the overfitting scores received from the subset of clients, wherein the overfitting scores of the particular client are suspicious when the loss related to the training dataset is improving while the loss related to the training dataset is worsening; and
initiating a security protocol.
